(19) United States
(12) Patent Application Publication
(10) Pub. No.: US 2005/0197808 A1
(43) Pub. Date: Sep. 8, 2005

(54) Method for determining electrical and magnetic field effects

(76) Inventor: An-Yu Kuo, San Jose, CA (US)

Correspondence Address: VICTOR H. OKUMOTO, P.O. BOX 6120, FREMONT, CA, 94538, US

(21) Appl. No.: 11/073,948

(22) Filed: Mar. 7, 2005

Related U.S. Application Data
(60) Provisional application No. 60/551,294, filed on Mar. 8, 2004.

(51) Int. Cl. G06F 17/10

(52) U.S. Cl. 703/2

(57) ABSTRACT

A method for determining electrical and magnetic field effects determines Lanczos matrices by performing a preconditioned conjugate gradient method using a nested multi-grid, vector and scalar potential preconditioner so that Pade via Lanczos frequency expansion may be used to determine the electrical and magnetic field effects over a frequency range without having to perform computationally slow and memory intensive matrix decomposition.

### CROSS REFERENCE TO RELATED APPLICATIONS

This application claims priority to U.S. provisional application Ser. No. 60/551,294 filed Mar. 8, 2004, which is incorporated herein by reference.

### FIELD OF THE INVENTION

The present invention generally relates to computer implemented methods for solving Maxwell's equations and in particular, to a computer implemented method for determining electrical and magnetic field effects.

### BACKGROUND OF THE INVENTION

Electronic circuit designs are getting smaller and more complex in geometry, while their operating frequencies are getting higher. As a result, electronic circuit designers rely on numerical simulation to predict electrical and magnetic fields of their designs before manufacturing. Currently available simulation tools, however, fail to solve many practical problems due to large computer memory requirements and long computation times.

For a given electronic circuit design, electrical and magnetic fields may be calculated using Maxwell's equations:
∇×\vec{E}=−jω\vec{B}
∇×\vec{H}=jω\vec{D}+\vec{J}
∇·\vec{D}=ρ
∇·\vec{B}=0 (1)
where E is the electrical field, H is the magnetic field, D is the electric flux density, B is the magnetic flux density, J is the current density, ω is the angular frequency, ρ is the electric charge density, and j=\sqrt{−1}.

Numerical methods such as the finite element method or the integral equation method can be used to solve the Maxwell equations. For details on the finite element method, see, e.g., Silvester, P. P., and Ferrari, R. L, “Finite Elements for Electrical Engineers”, 3^{rd} ed., Cambridge University Press, Chapter 9, 1996. For details on the integral equation method, see, e.g., Sun, D. K., Lee, J. F., and Cendes, Z. J., “ALPS-A New fast Frequency-Sweep Procedure for Microwave Devices,” IEEE Trans. Microwave Theory Tech., pp. 398-402, 2001.

Using these numerical techniques, the Maxwell equations may be transformed into a set of algebraic simultaneous equations:
([Kₒ]−ω[K₁]−ω²[Mₒ]){x}=ω{b} (2)
where [Kₒ], [K₁], and [M₀] are known matrices, {x} is the unknown electrical field, and {b} is a known electrical excitation.

Computer simulation may then be performed to solve equation (2) for the electrical field, {x}, at all frequencies of interest. Upon obtaining the electrical field, {x}, the corresponding magnetic field can be calculated using Maxwell's equations (1).

The Pade Via Lanczos Method

When analyzing an electronic circuit design, it may be necessary to calculate the electrical and magnetic fields at, for example, about 1,000 different frequencies to cover the application frequency range. One way to do this is to first calculate the electrical field, {x} in equation (2), at just one frequency point and then, expand the solution at this frequency to other frequencies. This frequency expansion technique is known as the “Pade via the Lanczos” method, or alternatively, the Krylov subspace method.

FIG. 1 illustrates, as an example, various steps performed in the Pade via the Lanczos method. In 101, Maxwell's equations (1) are transformed into the set of algebraic simultaneous equations (2). In 102, an LU decomposition of [K₀] is performed so that matrices [L] and [U] are found such that [K₀]=[L][U], where [L] is a lower triangular matrix (i.e., zero for all elements above the diagonal) and [U] is an upper triangular matrix (i.e., zero for all elements below the diagonal). For an example of how the LU decomposition may be performed, see, e.g., Press, W. H., et al, “Numerical Recipes,” Cambridge Press, London, pp. 31-38, 1986.

In 103, Lanczos Matrices of [K₀]⁻¹[K₁] are then determined, where [K₀]⁻¹ is the inverse matrix of [K₀] and [K₀]⁻¹=[U]⁻¹[L]⁻¹. For an example of how the Lanczos Matrices may be determined, see, e.g., Z. Bai, J. Demmel, J. Dongarra, A. Ruhe and H. van der Vorst, editors, “Templates for the solution of Algebraic Eigenvalue Problems: A Practical Guide,” SIAM, Philadelphia, pp. 189-196, 2000.

In 104, the Pade via Lanczos frequency expansion is then performed. For examples of how the Pade via Lanczos frequency expansion may be performed, see, e.g., Feldmann, P., and Freund, R. W., “efficient Linear Circuit Analysis by Pade Approximation via the Lanczos Process,” IEEE trans. Computer-Aided Design, Vol. 34, pp. 639-649, 1995; Bracken, J. E., Sun, D. K., and Cendes, Z. J., “S-domain Methods for Simultaneous Time and Frequency Characterization of Electromagnetic Devices,” IEEE Trans. Microwave Theory Tech., pp. 1277-1290, 1998; and Sun, D. K., Lee, J. F., and Cendes, Z. J., “ALPS-A New fast Frequency-Sweep Procedure for Microwave Devices,” IEEE Trans. Microwave Theory Tech., pp. 398-402, 2001.

The LU decomposition of matrix [K₀] performed in 102, however, is not only very slow but also very memory intensive. As a result, it is generally not practical to simulate a typical electronic circuit design using the Pade via the Lanczos method.

The NMGAV Method

Another method for solving Maxwell's equations is the Nested Multi-Grid, Vector (A) and Scalar (V) Potential Preconditioner (NMGAV) method. Details on this method may be found in Zhu, Yu, “Methodologies and Methods for Fast Finite-Element Analysis of Electromagnetic Devices and Systems”, Ph.D. Thesis, University of Illinois at Urbana-Champaign, Chapter 7, 2002 (the “Zhu reference.

The NMGAV method uses an iterative procedure to find solutions instead of using a direct matrix solver. In an iterative solution method, the solution is approximated iteratively until the residual (i.e., difference between the exact and approximated solutions) is very small. A good iterative solver can converge sooner than others.

In the computation of Maxwell's equations, there may be spurious modes that significantly slow down the convergence of an iterative solver, however. For details and examples of such spurious modes, see, e.g., Dyczij-Edlinger, R., Peng, G., and Lee, J. F., “Stability Conditions for Using TVFEMs to Solve Maxwell Equations in the Frequency Domain,” International Journal of Numerical Modeling: Electronic Networks, Devices and Fields, Vol. 13, Issue 2-3, pp.245-260, 2000.

The NMGAV method uses the AV preconditioner and the nested multi-grid method to screen out the spurious modes. As a result, a convergent solution can be obtained in less than, for example, 30 iterations, versus thousands of iterations by other iterative methods. As a result of its quick convergence, the NMGAV method can calculate electrical and magnetic solutions at a single frequency two orders of magnitude faster than the corresponding portion of the Pades via Lanczos method described above. In addition to its speed advantage, computer memory requirements for this method are relatively quite small. This is because no matrix inversion or decomposition is needed in this method. Also, because of its low memory requirement, the NMGAV method is practical for solving large problems.

An example of the NMGAV method follows:
1. If the coarsest grid, then solve A₀^{h}z_{E}^{h}=r_{E}^{h} with an LU direct solver or an iterative solver.
2. else
   a. pre-smooth Aₒ^{h}z_{E}^{h}=r_{E}^{h} using forward GS v₁ times with z_{E}=0
   b. rᵥ^{h}=G(r_{E}^{h}−A₀^{h}z^{h})
   c. pre-smooth Aᵥᵥ^{h}zᵥ^{h}=rᵥ^{h} using forward GS v₁ times with zᵥ=0
   d. z_{E}^{h}=z_{E}^{h}+G^{T}zᵥ^{h}
   e. r_{E}^{2h}=Iₕ^{2h}(r^{h}−A₀^{h}z_{E}^{h})
   f. z_{E}^{2h}=NMGAV (r_{E}^{2h})
   g. z_{E}^{h}=z_{E}^{h}+I₂ₕ^{h}z_{E}^{2h}
   h. rᵥ^{h}=G(r_{E}^{h}−A₀^{h}z^{h})
   i. post-smooth Aᵥᵥ^{h}zᵥ^{h}=rᵥ^{h} using backward GS v₁ times with zᵥ=0
   j. r_{E}^{h}=(r_{E}^{h}−A₀^{h}G^{T}zᵥ^{h})
   k. post-smooth A₀^{h}z_{E}^{h}=r_{E}^{h} using backward GS v₁ times with zᵥ=0
   l. z_{E}^{h}=z_{E}^{h}+G^{T}zᵥ^{h}
3. end if

FIG. 2 illustrates an example of an application of the NMGAV method according to the Zhu reference. In 201, a frequency is initially set to a lower limit frequency of an application frequency range. In 202, the algebraic simultaneous equations (2) are solved at the current frequency using the NMGAV method. In 203, a determination is made whether the current frequency is greater than or equal to an upper limit frequency of the application frequency range. If the determination in 203 is YES, then the method is completed and an END condition results. On the other hand, if the determination in 203 is NO, then in 204, the current frequency is incremented, and the method loops back to 202, so that the algebraic simultaneous equations (2) may be solved again at the incremented frequency.

Although the NMGAV method can speed up the solution of the simultaneous equations (2) at a single frequency by, for example, two orders of magnitude with a relatively much smaller computer memory requirement than the corresponding portion of the Pade via Lanczos method, solutions at all the frequencies of interest have to be calculated one by one. Repeating the solution process many times (such as, for example, 1,000 times) for the entire frequency range more than gives back the gain in the single frequency solution speed.

On the other hand, although the Pade via Lanczos method can obtain solutions at all frequencies by solving the simultaneous equations (2) only once, it requires an LU decomposition of the matrix [K₀] in the set of algebraic simultaneous equations (2), which is not only computationally slow but also computer memory intensive, making the Pade via Lanczos method impractical for large problems.

### OBJECTS AND SUMMARY OF THE INVENTION

Accordingly, it is an object of one or more aspects of the present invention is to provide a computer implemented method for determining electrical and magnetic fields that is computationally faster than the Pade via Lanczos and NMGAV methods.

Another object of one or more aspects of the present invention is to provide a computer implemented method for determining electrical and magnetic fields that requires less memory than the Pade via Lanczos method.

Still another object of one or more aspects of the present invention is to provide a computer implemented method for determining electrical and magnetic fields that provides results substantially the same as or of better accuracy than the Pade via Lanczos and NMGAV methods.

These and additional objects are accomplished by the various aspects of the present invention, wherein briefly stated, one aspect is a method for determining electrical and magnetic field effects, comprising: determining Lanczos matrices by performing a preconditioned conjugate gradient using a nested multi-grid, vector and scalar potential preconditioner; and performing a Pade via Lanczos frequency expansion to determine electrical and magnetic field effects over a frequency range.

Another aspect is an apparatus for determining electrical and magnetic field effects, comprising a processor configured to: determine Lanczos matrices by performing a preconditioned conjugate gradient using a nested multi-grid, vector and scalar potential preconditioner; and perform a Pade via Lanczos frequency expansion to determine electrical and magnetic field effects over a frequency range.

Still another aspect is a computer readable medium encoded with a method executable on a computer for determining electrical and magnetic field effects, comprising: determining Lanczos matrices by performing a preconditioned conjugate gradient using a nested multi-grid, vector and scalar potential preconditioner; and performing a Pade via Lanczos frequency expansion to determine electrical and magnetic field effects over a frequency range.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a flow diagram of a prior art Pade via Lanczos method for solving Maxwell's equations over an application frequency range.

FIG. 2 illustrates a flow diagram of a prior art NMGAV method for solving Maxwell's equations over an application frequency range.

FIG. 3 illustrates a flow diagram of a method for determining electrical and magnetic fields utilizing aspects of the present invention.

FIG. 4 illustrates a top plan view of a three-pole, low-pass filter interconnect structure.

FIG. 5 illustrates comparative frequency responses for S-parameters calculated by a point-by-point procedure and S-Parameters calculated by the method of the present invention for the three-pole, low-pass filter interconnect structure of FIG. 4.

FIG. 6 illustrates a computer system useful for practicing the method for determining electrical and magnetic fields utilizing aspects of the present invention.

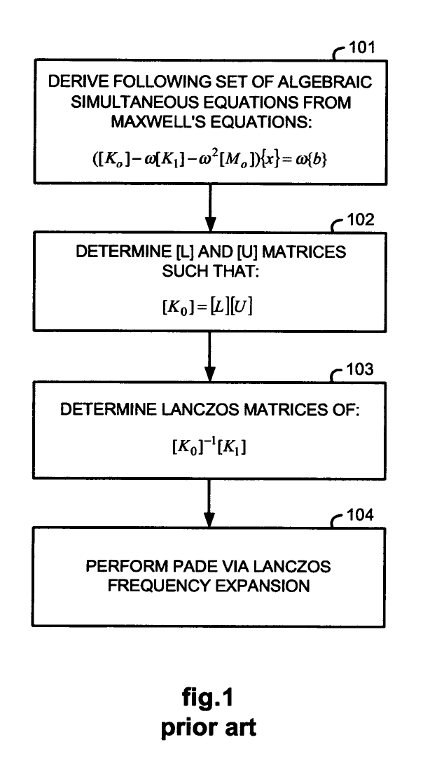

### DETAILED DESCRIPTION OF THE PREFERRED EMBODIMENT

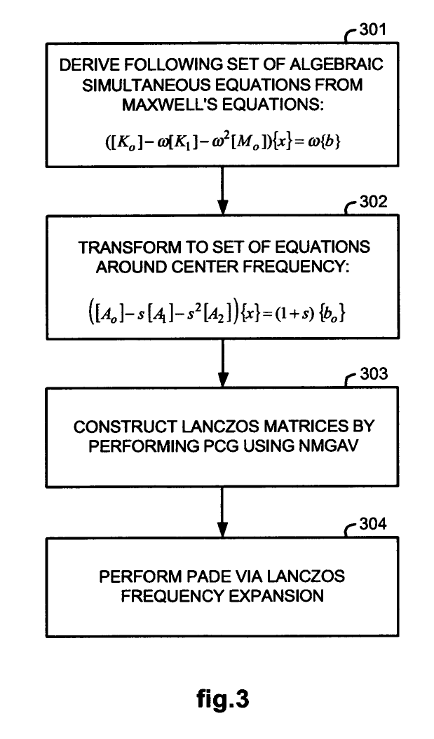

FIG. 3 illustrates, as an example, a computer implemented method for determining electrical and magnetic field effects so as to be useful for simulating integrated circuit, package, and board designs. The method combines certain aspects of the NMGAV and Pade via Lanczos methods in order to achieve superior performance while minimizing memory resource requirements.

In 301, the set of algebraic simultaneous equations (2) is formed from Maxwell's equations (1) using a conventional technique, such as the finite element method, the boundary element method, or the integral equation method.

In 302, an initial expansion frequency ωₒ is selected and the set of algebraic simultaneous equations (2) are re-written as follows:
([Kₒ]−ωₒ[K₁]−ωₒ²[Mₒ]){x}−(ω−ωₒ)([K₁]+2ωₒ[Mₒ]){x}−(ω−ωₒ)²[Mₒ]{x}=ω{b}
or
([Aₒ]−s[A₁]−s²[A₂]){x}=(1+s){bₒ} (3)
where

$$s = \frac{ω - {ω}_{o}}{{ω}_{o}} \qquad ( 4 )$$

[Aₒ]=[M_{EE}]=[Kₒ]−ωₒ[K₁]−ωₒ²[Mₒ] (5)
[A₁]=ωₒ[K₁]+2ωₒ²[Mₒ] (6)
[A₂]=ωₒ²[Mₒ] (7)
{bₒ}=ωₒ{b} (8)

Preferably, the initial expansion frequency ωₒ is approximately in the middle of the application frequency range of interest.

By using the HZR mass lumping method (as described, for example, in Cook, R. D., “Concept and Applications of Finite Element Analysis”, John Wiley & Sons, pp. 370-373, 1976), the matrix [Mₒ] can be approximated by a diagonal matrix [mₒ]. The HZR mass lumping method is useful in this case to get accurate solutions, especially when prism elements are used (as described, for example, in Sacks, Z. S. and Lee, J. F., “A Finite Element Time Domain Method Using Prism Elements for Microwave Cavities,” IEEE Trans. Electromagnetic Compatibilities, Nov. 1995).

Solving the set of equations (3) with a Lanczos solver has been found to be very slow. This is because it is desirable to capture the smallest eigenvalues of equations (3) to reach a solution convergence, but the Lanczos method captures far more largest eigenvalues than smallest eigenvalues.

Therefore, the set of equations (3) are rearranged as follows to accelerate the solution convergence.
(└A′ₒ┘−s└A′₁┘−s²└A′₂┘){y}=(1+s){b′ₒ} (9)
where

$$s = \frac{ω - {ω}_{o}}{{ω}_{o}} \qquad ( 10 )$$

[A′ₒ]=[A₂]⁻¹ (11)
[A′₁]=[A₂]⁻¹[A₁][A₀]⁻¹ (12)
[A′₂]=[A₀]⁻¹ (13)
{b′ₒ}=[A₂]⁻¹{bₒ} (14)
{x}=[A₀]⁻¹{y} (15)

By solving equation (9) for electrical fields {y}, the electrical fields {x} which are to be determined for equation (3) may be solved through equation (15).

In 303, the Lanczos matrices are constructed by performing a preconditioned conjugate gradient (PCG) method using the NMGAV method for the preconditioner. For details on the PCG method, see, e.g., Barrett, R. et al., “Templates for the Solution of Linear Systems: Building Blocks for Iterative Methods,” SIAM, Philadephia, p. 15, 1994.

[A′₀]=[A₂]⁻¹ is the preconditioner in the following PCG method. The relationship of [A′₀]⁻¹=[A₂] is used in the PCG method.

$$1. {y}_{0} = 0 ; {r}_{0} = {b}_{o}^{′} ; {z}_{0} = {A}_{2} {r}_{o} ; {p}_{0} = {z}_{0} ;$$

$${q}_{0} = \frac{{z}_{0}}{{( {r}_{0} , {z}_{0} )}^{1 / 2}} ; {r}_{0}^{″} = \frac{{r}_{0}}{{( {r}_{0} , {z}_{0} )}^{1 / 2}}$$

2. For j 32 0, 1, 2, 3, . . . , until convergence Do
a. solve Aₒtⱼ=pⱼ for tⱼ with the NMGAV method, tⱼ=NMGAV (pⱼ) (see below)

$$b . {α}_{j} = \frac{( {r}_{j} , {z}_{j} )}{( {t}_{j} , {p}_{j} )}$$
c. xⱼ₊₁=xⱼ+αⱼpⱼ
d. rⱼ₊₁=rⱼ−αⱼtⱼ
e. zⱼ₊₁=A₂rⱼ₊₁

$$f . {β}_{j} = \frac{( {r}_{j + 1} , {z}_{j + 1} )}{( {r}_{j} , {z}_{j} )}$$
g. pⱼ₊₁=zⱼ₊₁+βⱼpⱼ

$$h . {q}_{j + 1} = \frac{{z}_{j + 1}}{{( {r}_{j + 1} , {z}_{j + 1} )}^{1 / 2}} , {r}_{j + 1}^{″} \frac{{r}_{j + 1}}{{( {r}_{j + 1} , {z}_{j + 1} )}^{1 / 2}}$$
3. Enddo
   where [Q]=(q₀, q₁, q₂, . . . ) is the matrix containing all Lanczos vectors for use later in the frequency expansion, and the matrix [R]=(r′₀, r′₀, r′₀, . . . ) is useful in determining the signs of the Lanczos tri-diagonal matrix.

The Lanczos Matrices are then constructed, for example, as follows:
1. Form the following tri-diagonal matrix with the PCG constants αₖ and βₖ obtained in 302.

$$( 16 ) \\ [ {T}_{m} ] = [ \begin{matrix}( \frac{1}{{α}_{0}} ) & \frac{\pm \sqrt{{β}_{0}}}{{α}_{0}} & 0 & 0 & 0 \\ \frac{\pm \sqrt{{β}_{0}}}{{α}_{0}} & ( \frac{1}{{α}_{1}} + \frac{{β}_{0}}{{α}_{0}} ) & \frac{\pm \sqrt{{β}_{1}}}{{α}_{1}} & 0 & 0 \\ 0 & . & . & . & 0 \\ 0 & 0 & . & . & \frac{\pm \sqrt{{β}_{m - 2}}}{{α}_{m - 2}} \\ 0 & 0 & 0 & \frac{\pm \sqrt{{β}_{m - 2}}}{{α}_{m - 2}} & ( \frac{1}{{α}_{m - 1}} + \frac{{β}_{m - 2}}{{α}_{m - 2}} )\end{matrix} ]$$
2. (Optional) Obtain eigenvalues (λ₁, λ₂, . . . , λₘ) of [Tₘ] using the TQLI method [11].
3. (Optimal) Obtain eigenvectors [U]_{m×m}=(u₁, u₂, . . . , uₘ) by substituting (λ₁, λ₂, . . . , λₘ) into [Tₘ].

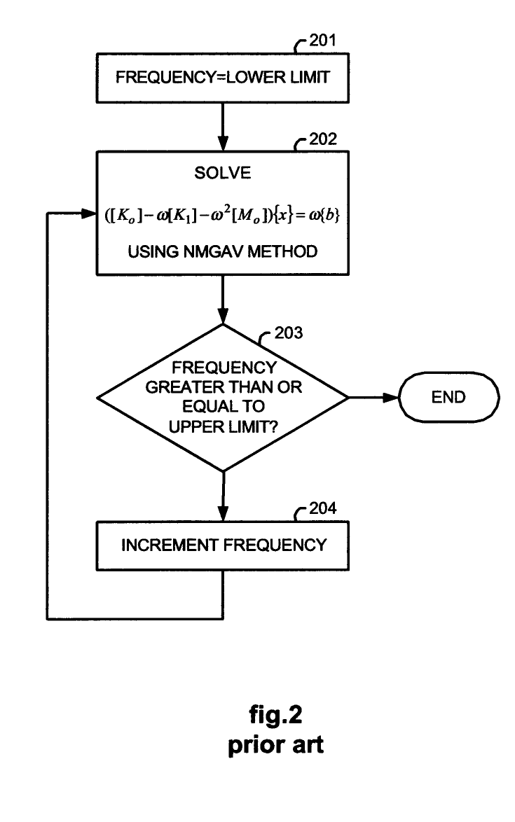

Equation (16) is an important contribution and aspect of the present invention that serves to bridge the PCG (using NMGAV) and Pade via Lanczos methods so that the NMGAV method can be employed to quickly determine a solution at an expansion frequency and the Pade via Lanczos method may be employed to perform frequency expansion around the expansion frequency for the application frequency range without repeatedly performing the NMGAV method as described in reference to FIG. 2. A proof of equation (16) is given in Appendix A.

The sign of each of the off diagonal terms in step 1 is determined by the famous Lanczos relationship of [A′₂][Q]=[A₀]⁻¹[Q]=[R][T], where the Lanczos matrices [Q] and [R] are obtained above during the PCG method.

$$\begin{matrix}\frac{\pm \sqrt{{β}_{0}}}{{α}_{0}} [ {A}_{0} ] \{ {r}_{1} \} = \{ {q}_{0} \} - \frac{1}{{α}_{0}} [ {A}_{0} ] \{ {r}_{0} \} & ( 18 ) \\ \frac{\pm \sqrt{{β}_{1}}}{{α}_{1}} [ {A}_{0} ] \{ {r}_{2} \} = \{ {q}_{1} \} - ( \frac{1}{{α}_{1}} + \frac{{β}_{0}}{{α}_{0}} ) [ {A}_{0} ] \{ {r}_{1} \} - \frac{\pm \sqrt{{β}_{0}}}{{α}_{0}} [ {A}_{0} ] \{ {r}_{0} \} \\ … . \\ … . & ( 19 ) \\ \frac{\pm \sqrt{{β}_{j}}}{{α}_{j}} [ {A}_{0} ] \{ {r}_{j + 1} \} = \{ {q}_{j} \} - ( \frac{1}{{α}_{j}} + \frac{{β}_{j - 1}}{{α}_{j - 1}} ) [ {A}_{0} ] \{ {r}_{j} \} - \frac{\pm \sqrt{{β}_{j - 1}}}{{α}_{j - 1}} [ {A}_{0} ] \{ {r}_{j - 1} \} & ( 20 )\end{matrix}$$

In the above calculation for the signs of the off diagonal terms, not all elements of the vectors are required. Only one non-zero element of the vectors, such as the element associated with a port, will be sufficient. Determining the signs of the off diagonal terms is an important step in the entire process. Without doing this, the final solutions may not be right.

In 304, a Pade via Lanczos frequency expansion is performed to calculate solutions at frequencies in the application frequency range. Applying the Lanczos congruent transformation to equation (9) and using the following Lanczos relationships:
[Aₒ]⁻¹[Q]−[R][Tₘ]=[A₂]⁻¹[Q][Tₘ] (21)
[Q]^{T}[A₂]⁻¹[Q]=[I] (22)
we have
[Q]^{T}([A′₀]−s[A′₁]−s²[A′₂])[Q]{z}=(1+s)[Q]^{T}{b′₀} (22)
or
([T₀]−s[T₁]−s²[T₂]){z}−(1+s)[Q]^{T}{b′ₒ} (23)
where
{y}=[Q]{z}
[T₀]=[Q]^{T}[A′₀][Q]=[I]
[T₁]=[Q]^{T}[A′₁][Q]=[Q]^{T}[A₂]⁻¹[A₁][A₂]⁻¹[Q][Tₘ]
[T₂]=[Q]^{T}[A′₂][Q]=[Tₘ] (24)

In the above equations, [T₁] can be obtained very quickly because [A₂]=ωₒ²[mₒ] is a diagonal matrix.

Therefore,

$$\begin{matrix}\{ x \} = {[ {A}_{0} ]}^{- 1} \{ y \} = {[ {A}_{0} ]}^{- 1} [ Q ] \{ z \} \\ = {( 1 + s ) [ {A}_{0} ]}^{- 1} [ Q ] \\ {{( [ I ] - s [ {T}_{1} ] - {s}^{2} [ {T}_{m} ] )}^{- 1} [ Q ]}^{T} \{ {b}_{o}^{′} \} \\ = ( 1 + s ) {{( {b}_{o}^{′} , {b}_{o}^{′} )}^{1 / 2} [ {A}_{2} ]}^{- 1} [ Q ] [ {T}_{m} ] \\ {( [ I ] - s [ {T}_{1} ] - {s}^{2} [ {T}_{m} ] )}^{- 1} \{ {e}_{1} \}\end{matrix} \qquad ( 25 )$$

Since the PCG method converges very quickly (e.g., about 50 iterations), dimensions of [I], [T₁], and [Tₘ] are very small (e.g., less than 50). As a result, inversion of the matrix ([I]−s[T₁]−s²[Tₘ]) at any frequency s can be computed very quickly with any matrix inversion numerical method. Inversion of [A₂]=ωₒ²[m] is trivial, since it is a diagonal matrix.

One way to ensure that equation (25) is correct is to check the solution at the expansion frequency ωₒ (or s=0). At s=0,

$$\begin{matrix}\{ x \} = {{[ {A}_{0} ]}^{- 1} [ Q ] [ Q ]}^{T} \{ {b}_{o}^{′} \} \\ = {{{[ {A}_{0} ]}^{- 1} [ Q ] [ Q ]}^{T} [ {A}_{2} ]}^{- 1} \{ {b}_{o} \} = {[ {A}_{0} ]}^{- 1} \{ {b}_{o} \} \\ ( {{[ Q ] [ Q ]}^{T} [ {A}_{2} ]}^{- 1} = {{[ Q ]}^{T} [ {A}_{2} ]}^{- 1} [ Q ] = [ I ] )\end{matrix} \qquad ( 26 )$$

which is indeed the solution of equation (3) at s=0.

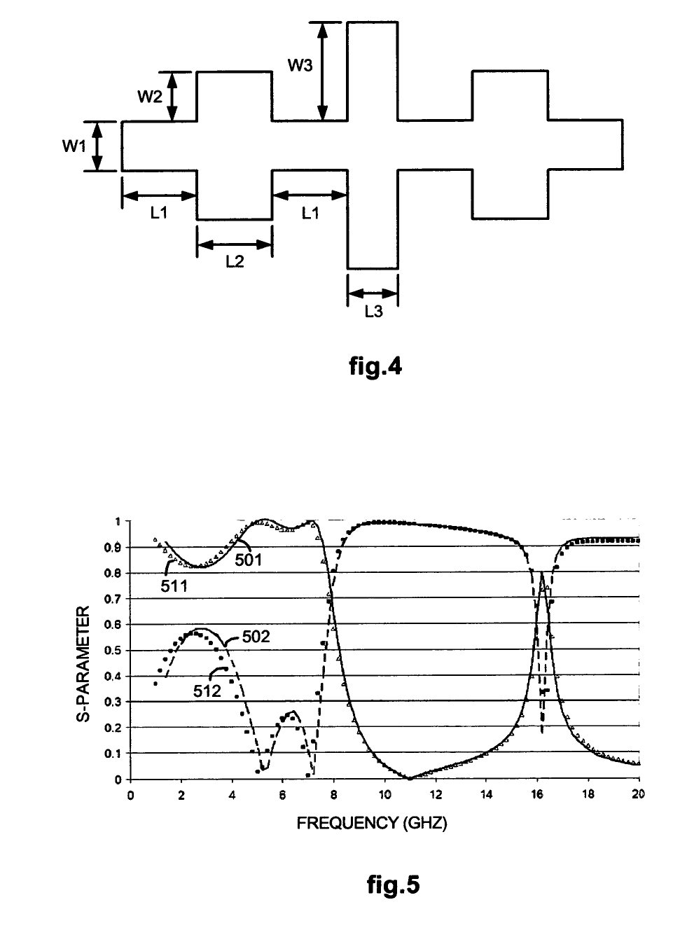

FIGS. 4 and 5 are provided, as an example, to illustrate the effectiveness of the method for determining electrical and magnetic field effects as described in reference to FIG. 3 compared to the prior art NMGAV method described in reference to FIG. 2.

Referring to FIG. 4, a top plan view of a microstrip, three-pole, low-pass filter interconnect structure is illustrated, having the following dimensions and characteristics:

L1=1.651 mm, L2=1.143 mm, L3=0.635 mm
W1=0.635 mm, W2=1.524 mm, W3=3.175 mm
Metal Thickness=0.06 mm
Substrate Thickness=0.635 mm
Substrate Dielectric Constant=9.6

Now referring to FIG. 5, comparative frequency responses for S-parameters S12 511 and S11 512 calculated by a point-by-point procedure using the NMGAV method described in reference to FIG. 2, and S-Parameters S12 501 and S11 502 calculated by the method of the present invention described in reference to FIG. 3 are illustrated for the interconnect structure of FIG. 4.

For both methods, the finite element model used for the interconnect structure consisted of the following:
Number of Triangular Prism Elements=16,644
Number of Nodes=9,912
Number of Edges=37,819

As can be readily seen from the figure, S-parameter S12 and S11 solutions, 501 and 502, obtained by using the proposed frequency expansion method are very close to the s-parameter solutions S12 and S11, 511 and 512, calculated by the point-by-point NMGAV method (taken at 0.2 GHz increments). Agreement between the two solutions is especially excellent near the expansion point of 10.5 GHz, which happens to be approximately in the middle of the application frequency range of 1 GHz (lower limit frequency) to 20 GHz (upper limit frequency).

However, the computer time used by the proposed frequency expansion method was found to be considerably less than that of the point-by-point NMGAV method. For example, using a Pentium 4 (3.0 GHz) computer with 2.0 GB of DRAM, the point-by-point NMGAV method took 2,302.7 seconds whereas the proposed frequency expansion method only took 218.5 seconds for a speedup ratio of 10.53.

As is apparent from the various references cited and incorporated herein by reference, the proposed frequency expansion method as described in reference to FIG. 3 has many applications, especially in the simulation of integrated circuits and other electronic devices, electronic device packaging, and printed wiring or circuit boards.

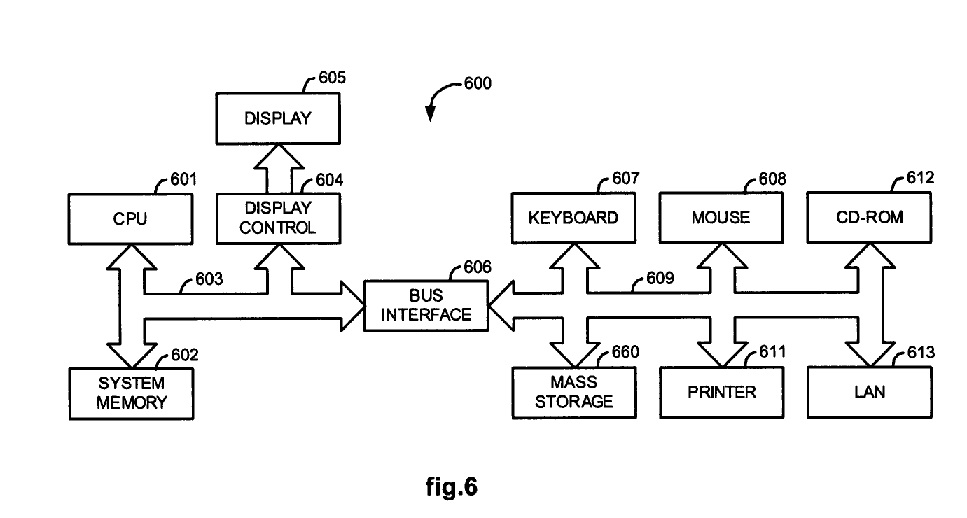

FIG. 6 illustrates, as an example, a computer system 600 useful for performing such simulations and practicing the method for determining electrical and magnetic fields described in reference to FIG. 3. The computer system 600 includes a central processing unit (CPU) 601 which may perform the method according to a computer program stored in mass storage 660 and executed using system memory 602 in a conventional manner. A CD-ROM drive 612 (or other computer readable medium drive) may be used to install the program from a CD-ROM disc (or other computer readable medium).

Although the various aspects of the present invention have been described with respect to a preferred embodiment, it will be understood that the invention is entitled to full protection within the full scope of the appended claims.

Appendix A—Derivation of the Relationship between Lanczos and PCG Methods.

We first review the Lanczos method for solving Ax−λMx=0.

$$\begin{matrix}1. {x}_{0} = 0 , {r}_{0} = {M}^{- 1} b , {v}_{0} = 0 , γ = {( {r}_{0} , {r}_{0} )}^{1 / 2} , {v}_{1} = \frac{{r}_{0}}{γ} , {η}_{1} = 0 \\ 2. For j = 1 , 2 , 3 , … , m Do & ( A1 ) \\ a . {w}_{j} = {M}^{- 1} {Av}_{j} - {η}_{j} {v}_{j - 1} & ( A2 ) \\ b . {δ}_{j} = {( {w}_{j} , {v}_{j} )}_{M} & ( A3 ) \\ c . {w}_{j + 1} = {w}_{j} - {δ}_{j} {v}_{j} & ( A4 ) \\ d . {η}_{j + 1} = {( {w}_{j + 1} , {w}_{j + 1} )}_{M}^{1 / 2} & ( A5 ) \\ e . {v}_{j + 1} = \frac{{w}_{j + 1}}{{η}_{j + 1}} & ( A6 )\end{matrix}$$

3. EndDo

$$4. [ {T}_{m} ] = [ \begin{matrix}{δ}_{1} & {η}_{2} & 0 & … \\ {η}_{2} & {δ}_{2} & {η}_{3} & … \\ 0 & & & … \\ … & … & {η}_{m} & {δ}_{m}\end{matrix} ] , [ {V}_{m} ] = [ \begin{matrix}{v}_{1} & {v}_{2} & … & {v}_{m}\end{matrix} ] \qquad ( A7 )$$

The residual vector of the approximation solution can be written as
(A−ΛₘM)[Vₘ]∝vₘ₊₁ (A8)

In the Lanczos method
Vₘ^{T}MVₘ=Iₘ or (vᵢ, vⱼ)_{M}=δᵢⱼ (A9)
AVₘ=MVₘTₘ+residual Tₘ≈Vₘ^{T}AVₘ (A10)

We then outline the PCG (preconditioned conjugate gradient) method for Ax=b with M as the preconditioner
1. x₀=0; rₒ=bₒ; z₀=(M)⁻¹r₀; pₒ=z_{o (A}11)
2. For j=0, 1, 2, 3, . . . , until convergence Do

$$\begin{matrix}a . {α}_{j} = \frac{( {r}_{j} , {z}_{j} )}{( {Ap}_{j} , {p}_{j} )} & ( A12 ) \\ b . {x}_{j + 1} = {x}_{j} + {α}_{j} {p}_{j} & ( A13 ) \\ c . {r}_{j + 1} = {r}_{j} - {α}_{j} {Ap}_{j} & ( A14 ) \\ d . {z}_{j + 1} = {( M )}^{- 1} {r}_{j + 1} & ( A15 ) \\ e . {β}_{j} = \frac{( {r}_{j + 1} , {z}_{j + 1} )}{( {r}_{j} , {z}_{j} )} & ( A16 ) \\ f . {p}_{j + 1} = {z}_{j + 1} + {β}_{j} {p}_{j} & ( A17 )\end{matrix}$$
3. EndDo

In the above method, rⱼ is residual of Ax=b, while zⱼ is residual of the preconditioned system M⁻¹Ax=M⁻¹b. From Eq (A8), it can be deduced that zⱼ in the PCG method is proportional to vⱼ₊₁, and thus wⱼ₊₁, in the Lanczos method. From Eqs (A2) and (A3) we have

$$\begin{matrix}{δ}_{j + 1} = {( {w}_{j + 1} , {v}_{j + 1} )}_{M} \\ = {( {M}^{- 1} {Av}_{j + 1} , {v}_{j + 1} )}_{M} \\ = \frac{{( {M}^{- 1} {Aw}_{j + 1} , {w}_{j + 1} )}_{M}}{{( {w}_{j + 1} , {w}_{j + 1} )}_{M}} \\ = \frac{{( {M}^{- 1} {Az}_{j} , {z}_{j} )}_{M}}{{( {z}_{j} , {z}_{j} )}_{M}} \\ = \frac{( {Az}_{j} , {z}_{j} )}{( {r}_{j} , {z}_{j} )} \\ \begin{matrix}( {Az}_{j} , {z}_{j} ) = ( A ( {p}_{j} - {β}_{j - 1} {p}_{j - 1} ) , ( {p}_{j} - {β}_{j - 1} {p}_{j - 1} ) ) \\ = ( {Ap}_{j} , {p}_{j} ) + {β}_{j - 1}^{2} ( {Ap}_{j - 1} , {p}_{j - 1} )\end{matrix} \begin{matrix}( p are A \\ orthogonal )\end{matrix} \\ {δ}_{j + 1} = \frac{( {Ap}_{j} , {p}_{j} )}{( {z}_{j} , {r}_{j} )} + {β}_{j - 1}^{2} \frac{( {Ap}_{j - 1} , {p}_{j - 1} )}{( {z}_{j - 1} , {r}_{j - 1} )} \frac{( {z}_{j - 1} , {r}_{j - 1} )}{( {z}_{j} , {r}_{j} )} \\ = \frac{1}{{α}_{j}} + \frac{{β}_{j - 1}}{{α}_{j - 1}}\end{matrix}$$

From Eq (A2), we have
(wⱼ₊₁, vⱼ)_{M}=0=(M⁻¹Avⱼ₊₁, vⱼ)_{M}−ηⱼ₊₁(vⱼ, vⱼ)_{M}=(M⁻¹Avⱼ₊₁, vⱼ)_{M}−ηⱼ₊₁

Therefore,

$$\begin{matrix}{η}_{j + 1} = {( {M}^{- 1} {Av}_{j + 1} , {v}_{j} )}_{M} \\ = \frac{{( {M}^{- 1} {Aw}_{j + 1} , {w}_{j} )}_{M}}{{‖ {w}_{j} ‖}_{M} {‖ {w}_{j - 1} ‖}_{M}} \\ = \frac{{( {M}^{- 1} {Az}_{j + 1} , {z}_{j} )}_{M}}{{‖ {z}_{j} ‖}_{M} {‖ {z}_{j - 1} ‖}_{M}} \\ = \frac{( {Az}_{j} , {z}_{j - 1} )}{{‖ {z}_{j} ‖}_{M} {‖ {z}_{j - 1} ‖}_{M}} \\ = \frac{( A ( {p}_{j} - {β}_{j - 1} {p}_{j - 1} ) , ( {p}_{j - 1} - {β}_{j - 2} {p}_{j - 2} ) )}{{( {r}_{j} , {z}_{j} )}^{1 / 2} {( {r}_{j - 1} , {z}_{j - 1} )}^{1 / 2}} \\ = \frac{( {Ap}_{j - 1} , {p}_{j - 1} )}{{( {r}_{j} , {z}_{j} )}^{1 / 2} {( {r}_{j - 1} , {z}_{j - 1} )}^{1 / 2}} \\ = \pm \frac{\sqrt{{β}_{j - 1}}}{{α}_{j - 1}}\end{matrix}$$

1. A method for determining electrical and magnetic field effects, comprising: determining Lanczos matrices by performing a preconditioned conjugate gradient using a nested multi-grid, vector and scalar potential preconditioner; and performing a Pade via Lanczos frequency expansion to determine electrical and magnetic field effects over a frequency range.

2. The method according to claim 1, wherein the preconditioned conjugate gradient is performed on a set of frequency dependent simultaneous equations derived from Maxwell's equations.

3. The method according to claim 2, wherein the set of frequency dependent simultaneous equations have been transformed so as to be shifted to a frequency approximately in the middle of the frequency range.

4. The method according to claim 1, wherein the electrical and magnetic field effects are determined for an integrated circuit.

5. The method according to claim 1, wherein the electrical and magnetic field effects are determined for an electronic device package.

6. The method according to claim 1, wherein the electrical and magnetic field effects are determined for a printed wiring board.

7. An apparatus for determining electrical and magnetic field effects, comprising a processor configured to: determine Lanczos matrices by performing a preconditioned conjugate gradient using a nested multi-grid, vector and scalar potential preconditioner; and perform a Pade via Lanczos frequency expansion to determine electrical and magnetic field effects over a frequency range.

8. The apparatus according to claim 7, wherein the preconditioned conjugate gradient is performed on a set of frequency dependent simultaneous equations derived from Maxwell's equations.

9. The apparatus according to claim 8, wherein the set of frequency dependent simultaneous equations have been transformed so as to be shifted to a frequency approximately in the middle of the frequency range.

10. A computer readable medium encoded with a method executable on a computer for determining electrical and magnetic field effects, comprising: determining Lanczos matrices by performing a preconditioned conjugate gradient using a nested multi-grid, vector and scalar potential preconditioner; and performing a Pade via Lanczos frequency expansion to determine electrical and magnetic field effects over a frequency range.

11. The computer readable medium according to claim 10, wherein the preconditioned conjugate gradient is performed on a set of frequency dependent simultaneous equations derived from Maxwell's equations.

12. The computer readable medium according to claim 11, wherein the set of frequency dependent simultaneous equations have been transformed so as to be shifted to a frequency approximately in the middle of the frequency range.
